(19) United States
(12) Patent Application Publication
(10) Pub. No.: US 2018/0011835 A1
(43) Pub. Date: Jan. 11, 2018

(54) Method of Lemmatization, Corresponding Device and Program

(71) Applicant: DAVI, Puteaux (FR)

(72) Inventors: Pascal Arbault, Guerigny (FR); Didier Bultiauw, Montigny Aux Amognes (FR)

(21) Appl. No.: 15/545,165

(22) PCT Filed: Jan. 19, 2016
(86) PCT No.: PCT/EP2016/051036

§ 371 Date: Jul. 20, 2017

(30) Foreign Application Priority Data
Jan. 20, 2015 (FR) 1550452

(51) Int. Cl. G06F 17/27

(52) U.S. Cl. CPC G06F 17/277; G06F 17/2735; G06F 17/2785

(57) ABSTRACT

A method is provided for creating a lexical tree from a statement in a natural language. The method is implemented by a natural-language processing module. The method includes: receiving a statement in natural language in the form of a string of characters; iteratively processing the statement as a function of at least one processing parameter and one ontological dictionary, delivering at least one relational graph corresponding to at least one lexical item included in the statement in natural language; and creating a data structure at output having all possible combinations of the lexical items of the statement in natural language on the basis of the at least one relational graph.

### 1. FIELD OF THE INVENTION

The present disclosure relates to the automated processing of natural language. The present disclosure relates more particular to a method of lemmatization. Accessorily, the proposed technique also relates to a method for generating an ontological dictionary.

### 2. PRIOR ART

Recent decades have been marked by a constant increase in man-machine interactions, especially in the field of information technology. The growing adoption by users of digital devices such as computers, tablets and smartphones has led to numerous problems of ergonomy. The primary man/machine interaction device is the screen. Such a screen especially comprises numerous man/machine interfaces (MMI).

To facilitate the development of applications and to make interactions simpler for users, MMIs conventionally use monofunctional elements with limited and closed choices. The constantly growing complexity of machines has been the subject of much advanced research in the field of ergonomy to overcome initial constraints including the constraint of comprehension between man and machine.

The advances made have taken the form of:
entry tools (keyboards, mouse-type devices, graphic tablets, touchscreens etc.);
the visual representation of information (windowing);
command data entry zones (text fields, buttons, cursors etc.).

However, because of very crippling initial constraint (related to very limited understanding on the part of the machine), the user has to carry out a pre-processing operation: to make the machine perform an action or to obtain information from the machine, the user must carry out a decomposition into elementary tasks. The user must therefore learn how to use the interface itself, even though he has a general perspective on the functions of the machine and of the information that it contains. To start a machine, it is simpler to ask it to start. However, at present, the user must carry out a sequence of operations needed for starting (i.e. turn on the contact, press a button etc.).

These issues and problems are all the more amplified as present-day machines are not simply action machines but also information-providing machines. A simple request such as “what time will the next train go from Paris to Brussels?” requires a sequence of actions with classic MMIs (connection to the provider, searches for information etc.) that can soon become complex and time-consuming. The development of MMIs therefore requires that machines should understand natural language. To enable this understanding, present-day machines use especially lemmatizers and dictionaries.

There exist lemmatizing systems integrated with a different language-processing software, especially for spellcheckers (for example the Cordial product by the firm Synapse) or for translation systems (by the Promt firm). Autonomous lemmatizers are also available: TreeTagger or BONSAI (INRIA). The lemmatizers are all oriented to generating syntagmatic or lexico-morpho-syntactic trees. And the efforts made have been oriented towards removing ambiguity because one and the same sentence can correspond to several possibilities of signifying trees. The techniques used to rely on stochastic approaches.

The output of present-day lemmatizers is very poor from the semantic viewpoint. These lemmatizers do not recognize ready-made forms (idioms, proverbs etc.). The data obtained from at output from the lemmatizer is therefore not immediately open to use.

An idiom or a proverb must necessarily be “re-assembled” in order to obtain its meaning. it can also give rise to a phenomenon of noise for example because of the use, in a idiom or proverb, of a word with multiple meanings. Thus the work needed to retrieve the exact meaning of an idiom or proverb becomes a drain on resources. What is true for a proverb is also true for ready-made sentences. This raises firstly problems of processing and secondly problems of excessive consumption of resources. Besides, with present-day techniques, it is not necessarily certain that the meaning of the idiom or the proverb is finally the right one. The meaning “retrieved” by combining the meanings of the individual terms that correspond to the idiom or the proverb will probably be different from its overall meaning.

### 3. SUMMARY OF THE INVENTION

The proposed technique does not have these drawbacks of the prior art. More particularly, the proposed technique relates to a method and a device for processing statements or utterances in natural language. More particularly, the technique described relates to a method for creating a lexical tree from a statement in natural language, method implemented by a natural-language processing module, which method is characterized in that it comprises the steps of:
receiving a statement in natural language in the form of a string of characters;
iteratively processing said statement as a function of at least one processing parameter and one ontological dictionary, delivering at least one relational graph corresponding to at least one lexical item included in said statement in natural language;
creating a data structure at output comprising all possible combinations of the lexical items of said statement in natural language on the basis of said at least one relational graph.

According to one particular characteristic, the iterative processing of said statement as a function of at least one processing parameter and an ontological dictionary comprises:
a step for initializing a cursor at the beginning of the statement and a cursor at the end of the statement;
at least one iteration of the following steps, until the cursor c1 is positioned at the end of the statement:
   searching, within the dictionary, for a lexical item corresponding to a group of words situated between the cursor c1 and cursor c2; and
   when a lexical item is identified in the dictionary by the previous step, taking said lexical item into account and modifying the cursors;
   when no lexical item is identified in the dictionary by the step of searching, a step for shifting the position of the cursor c2 to the level of the separator of the preceding word in the statement.

According to one particular characteristic, the step of taking said lexical item into account and modifying the cursors comprises:
a step for processing the lexical item delivering a relational graph of the lexical items;
a step for positioning the cursor c1 at the position of the cursor c2;
a step for positioning the cursor c2 at the end of the statement.

According to one particular characteristic, said step for processing the lexical item delivering a relational graph of the lexical item comprises:
a step for identifying at least one lexical entry associated with the lexical item; this identification is made from the ontological dictionary.
a step for obtaining a lexical form of the lexical item;
a step for obtaining a canonical form of the lexical entry;
a step for identifying at least one lexical entry associated with the lexical form of the lexical item as a function of canonical form;
a step for obtaining a form of the lexical entry;
a step for obtaining at least one piece of data representing a lexical sense of the each of the forms obtained previously.
a step for building said relational graph on the basis of said lexical entries, said lexical forms and said lexical senses obtained previously.

According to another aspect, the described technique also relates to a device for creating a lexical tree on the basis of a statement in natural language, the device being implemented by a module for processing natural language.

Such a device comprises means for:
receiving a statement in natural language in the form of a string of characters;
iteratively processing said statement as a function of at least one processing parameter and one ontological dictionary, delivering at least one relational graph corresponding to at least one lexical item included in said statement in natural language;
creating at output a data structure comprising all the possible combinations of lexical items of said statement in natural language as a function of said at least one relational graph.

According to a preferred implementation, the different steps of the methods according to the proposed technique are implemented by one or more software programs or computer programs comprising software instructions that are to be executed by a data processor of a relay module according to the proposed technique, these programs being designed to control the execution of different steps of the methods.

The invention is therefore also aimed at providing a program capable of being executed by a computer or by a data processor, this program comprising instructions to command the execution of the steps of a method as mentioned here above.

This program can use any programming language whatsoever and can be in the form of source code, object code or intermediate code between source code and object code such as in a partially compiled form or in any other desirable form whatsoever.

The proposed technique is also aimed at providing an information medium readable by a data processor, and comprising instructions of a program as mentioned here above.

The information medium can be any entity or communications terminal whatsoever capable of storing the program. For example, the medium can comprise a storage means such as a ROM, for example, a CD ROM or microelectronic circuit ROM or again a magnetic recording means, for example a floppy disk or a hard disk drive.

Furthermore, the information medium can be a transmissible medium such as an electrical or optical signal that can be conveyed via an electrical or optical cable, by radio or by other means. The program according to the proposed technique can especially be uploaded to an Internet type network.

As an alternative, the information carrier can be an integrated circuit into which the program is incorporated, the circuit being adapted to executing or to being used in the execution of the method in question.

According to one embodiment, the proposed technique is implemented by means of software and/or hardware components. In this respect, the term “module” can correspond in this document equally well to a software component as to a hardware component or to a set of hardware and software components.

A software component corresponds to one or more computer programs, one or more sub-programs of a program or more generally to any element of a program or a piece of software capable of implementing a function or a set of functions according to what is described here below for the module concerned. Such a software component is executed by a data processor of a physical entity (terminal, server, gateway, router etc) and is capable of accessing the hardware resources of this physical entity (memories, recording media, communications buses, input/output electronic boards, user interfaces etc.).

In the same way, a hardware component corresponds to any element of a hardware assembly capable of implementing a function or a set of functions according to what is described here below for the component concerned. It can be a programmable hardware component or a component with an integrated processor for the execution of software, for example, an integrated circuit, smart card, a memory card, an electronic board for the execution of firmware etc.

Each component of the system described here above can of course implement its own software components.

The different embodiments mentioned here above can be combined with one another to implement the proposed technique.

### 4. FIGURES

Other features and advantages of the invention shall appear more clearly from the following description of a preferred embodiment, given by way of a simple illustratory and non-exhaustive example and from the appended drawings, of which:

FIG. 1 is a block diagram of the proposed technique;

FIG. 2 presents a system in which the proposed technique can be implemented;

FIG. 3 describes the obtaining of a relational graph;

FIG. 4 describes a device for creating a dictionary according to the present technique;

FIG. 5 describes a device for creating a lexical tree according to the present technique;

FIG. 6 represents a classic syntactic tree;

FIG. 7 represents a lexical tree according to the present technique.

### 5. DESCRIPTION

### 5.1. Definitions

Ontology in information technology is a way of trying to represent knowledge, i.e. that which exists in the broad sense (which is effectively similar to the object of ontology in philosophy which is the description of the world): objects, immaterial concepts and relationships that exist between these different elements.

One mode of representation chosen is a representation in triplets {subject, predicate, object} that can be stored under different standards (RDF, OWL, TDB etc.). This definition is unique. The predicate representing the type of relationship is not restrictive and can very well represent grammatical relationships if the objects and the subjects concerned are the written forms of a language.

On the other hand, the use of these representations can be multiple and, for the object concerned by the present patent, we need to represent the grammatical knowledge of a language and the semantic knowledge of a language. The dictionary encompasses both these perspectives based on a model recognized by those skilled in the art: these models are the Lemon and Lexinfo models.

A semasiological and onomasiological distinction could be made. This distinction qualifies rather the use that is made of the ontological dictionary and not the nature of this dictionary, above all in the mode of the representation chosen in the context of the present invention.

A lexical item is any written form in a language. This ranges from a simple word to proverbs, all idiomatic forms, idioms etc. The implementing of a lexical unit is a lexical form (the concept Lexicalform in the ontological module Lemon for example).

A lexeme is the association of non-inflectional lexical item and a sense. For example:
The word “taste” used as a noun naming that which is tasted is a lexeme that has the associated lexical items “taste” and “tastes”.
“(to) taste” naming the fact of tasting is a lexeme that has the associated lexical items “taste” and “tastes”.
“(to) taste” as a verb associated with the various senses of this verb” covers other lexemes which have all its conjugate forms as their lexical items.

The implementing of a lexeme therefore corresponds to the following graph:
one lexical entry per inflectional category (the concept LexicalEntry in the Lemon model): taste” as a noun will have only one lexical item because in every case, the inflections are identical but “one” as a noun will have two entries because the inflections of the digit “one” are “one” and “ones”. On the contrary, its use by metonymy to indicate an object bearing the number one has no inflection.
an associated sense (sense predicate sense LexicalSense concept in the Lemon ontological module);
a lexical form associated by the canonical form predicate (canonical form in the Lemon ontological model).

### 5.2. General Principle

The general principle that is the basis of the proposed technique is that of providing a statement in natural language to a lemmatizer, this statement being lemmatized without removing the ambiguities resulting from the lemmatization. The processing device that implements the described technique does not remove the ambiguities. Using a specific dictionary comprising weighted relationships between the words that compose it, the lemmatizer provides a data structure (for example an xml file) in which the different lemmas that comprise the statement are listed. These lemmas, which compose the statement, are accompanied according to the present disclosure, by a definition (i.e. a sense) and grammatical rules. Naturally, these different elements which accompany the lemmas of the data structure are formed on the basis of the analysis of the statement provided at input to the lemmatizer.

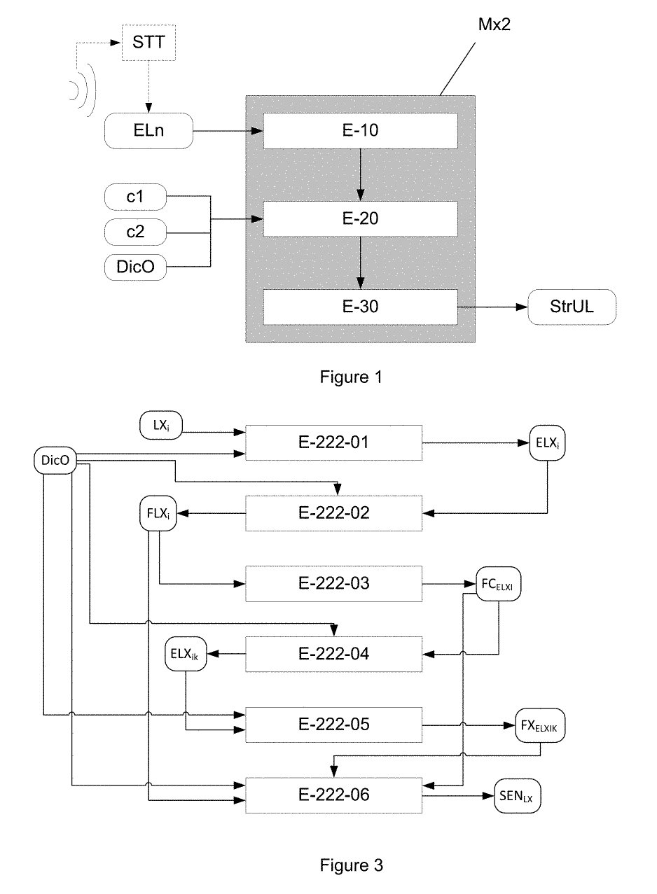

Referring to FIG. 1, a description is provided of general principle of the proposed technique. A software or hardware module (Mx2) receives, (E-10) a statement in natural language (ELn) at input. It processes (E-20) this statement and outputs (E30) a data structure (StrUL) comprising all the possible combinations of lexical items. This processing operation (E20) is implemented using especially processing parameters (c1, c2) and an ontological dictionary (DicO).

The data structure (StrUL) associates grammatical data and semantic data extracted from the dictionary (DicO) with each lexical item identified.

More particularly, the method comprises the following steps:
receiving (E-10) a statement in natural language (ELn) in the form of a string of characters;
iteratively processing (E-20) said statement as a function of at least one processing parameter (c1, c2) and one ontological dictionary (DicO) delivering at least one relational graph (Gr_{Rel}^{LXi}) corresponding to at least one lexical item (LXi) included in said statement in natural language (ELn);
creating (E-30) a output data structure (StrUL) comprising all the possible combinations of lexical units of said statement in natural language (ELn) as a function of said at least one relational graph (Gr_{Rel}^{Lxi}).

Different embodiments can be envisaged. More particularly, prior to the processing, the statement in natural language can undergo pre-processing, especially for example processing to convert a digital voice file into a textual statement. The processing of the textual statement on the basis of the dictionary and of the processing parameter comprises especially the sub-division of the statement using term separators adapted to the language to be processed (such as the comma, full stop, semicolon etc.). To resolve the problems mentioned here above, the statement is considered to be one with its own sense. Rather than searching for a sense for each word composing the statement, a search is made on the contrary for an overall sense of the statement. To this end, the statement is processed as a lexical item and a direct search is made within the ontological dictionary. When this search does not deliver any result, the processing parameters c1 and/or c2 are modified in order to search for a shorter lexical item. This iterative processing is implemented to obtain lexical items that are present in the ontological dictionary, and have a maximized size. If a lexical item relates to a single term, then it is the sense or senses of this term that are selected. When a lexical item corresponds to an idiom or to a complete sentence, a single sense is obtained from the ontological dictionary: this is far more efficient.

The solution presented in this document is a tool enabling a first processing step after “speech-to-text” (STT) conversion, if any, enabling the sense of a statement to be used by a machine.

This processing consists of a lemmatization of the concept-oriented and semantics-oriented statement by using self-evolving dictionaries.

The data structure (StrUL) obtained is also called a lexical tree. A lexical tree is a mode of representation specific to the object of the present invention and is not in common usage in the field. To explain the differences between “lexical tree” and other known structures, the invention uses the representation of the following example of a sentence: “he wants to “taste” a cheese fondue.

In the language of linguistic information technology, we can two main terminologies, namely:
lexicographic tree;
syntactic or morpho-syntactic tree.

A lexicographic tree is a mode of representation of a purely lexicographic dictionary and does not relate to the subject of the present invention.

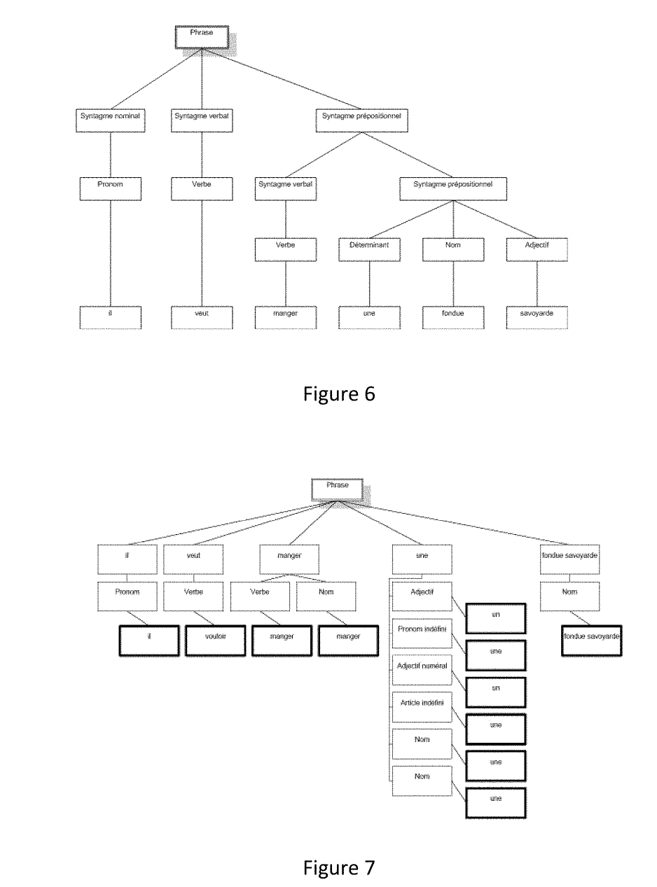

A syntactic or morpho-syntactic tree, described in the relevant literature, has the sentence as its root. The root has one or more children representing syntagms or morpho-syntactic categories. A syntagm node can have one or more children representing syntagms or morpho-syntactic categories. A morpho-syntactic node has an son node corresponding to a word-type lexical item. For example the morpho-syntactic tree corresponding to the example of a sentence is presented in FIG. 6.

This commonly used structure is not chosen in the context of the present technique. This is for two reasons:
there may be several different trees for one and same sentence;
the technique meets a need for processing sentences that are not necessarily well structured grammatically: it is therefore not always possible to build a structure such as the one presented in FIG. 6.

Thus the inventors have opted for a representation called a “lexical tree” which is described as follows:
the root is the sentence;
the children of the roots are the lexical items detected in the sentence, these lexical items being identified for example in the step of searching in a dictionary (E-221, see 5.3);
the children of these lexical items are the morpho-syntactic categories possible for these lexical items;
each morpho-syntactic category has the canonical form (or lemma), along with associated semantic data, as its son. This terminal part of the tree is built when obtaining the relational graph (E-222, see 5.3).

For example, the lexical tree corresponding to the exemplary sentence is presented in FIG. 7 (for the sake of readability, the semantic nodes are not included).

From the leaves representing the lemma (encircled in bold), it is possible to build two lemmatized sentences:
he wants to taste a cheese fondue;
he wants to taste one cheese fondue.

In other words, the lexical tree of the present invention is a morphological and a semantic hypothesis tree of a statement; this lexical tree should not be mistaken for the trees mentioned here above.

### 5.3. Description of One Embodiment

The lemmatizer of the present technique uses one ontological dictionary per language represented for example in the form of a store triplet: {subject, relation, subject}. The lemmatizer takes the form of a (software or hardware) module integrated within a particular device or processing system. The data-storage technique varie according to firstly the volume of this data and secondly the performance levels of the processes for accessing this data.

This embodiment presents the processing technique used to obtain a complete graph of the statement in natural language.

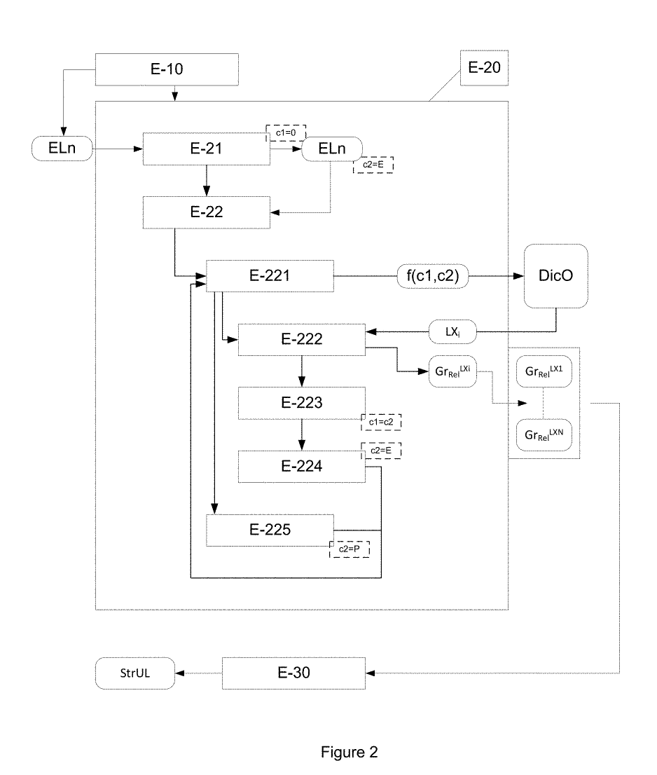

More particularly, in this embodiment of the technique described with reference to FIG. 2, the following processing algorithm is applied:
a statement (ELn) in natural language is transmitted (E-10) to the module.
the processing (E-20) of the statement (ELn) comprises:
   a step of initialization (E-21) of two cursors: one cursor (c1) at the start of the statement (ELn) and one cursor (c2) at the end of the statement (ELn);
   at least one iteration (E-22) of the following steps until the cursor c1 is positioned at the end of the statement (ELn):
      a search (E-221), within the dictionary (DicO), for a lexical item corresponding to a group of words situated between the cursor c1 and the cursor c2; and
      when a lexical item (LXᵢ) is identified in the dictionary (DicO) by the preceding step (E-221):
         a step (E-222) for processing the lexical unit (LXᵢ) delivering a relational graph (Gr_{Rel}^{LXi}) of the lexical item (LXᵢ);
         a step (E-223) for positioning the cursor 1 at the position of the cursor c2;
         a step (E-224) for positioning the cursor c2 at the end of the statement;
      when no lexical item is identified in the dictionary (DicO) by the search step (E-221), a step (E-225) for shifting the position of the cursor c2 to the separator of the preceding word in the statement.
creation (E-30) of the data structure (StrUL) comprising the set of combinations of possible lexical items on the basis of all the relational graphs (Gr_{Rel}^{LXi}) of the lexical items (LXᵢ) of the statement, 1≦i≦N, with N designating the number of lexical items identified in the statement in natural language.

When a lexical item (LXᵢ) is identified in the sentence submitted at entry, a step (E-222-0) for obtaining a relational graph (Gr_{Rel}^{LXi}) of the lexical item (LXᵢ) is implemented. More particularly, as described with reference to FIG. 3 on the basis of the lexical item (LXᵢ), the obtaining (E-222-0) of the relational graph comprises:
a step (E-222-01) for identifying at least one lexical entry (ELXᵢ) associated with the lexical item (LXᵢ); this identification is done on the basis of the ontological dictionary.
a step (E-222-02) for obtaining a lexical form (FLXᵢ) of the lexical item (LXᵢ);
a step (E-222-03) for obtaining a canonical form (FC_{ELXI}) of the lexical entry (ELXᵢ);
a step (E-222-04) for identifying at least one lexical entry (ELXᵢₖ) associated with the lexical form (FLXᵢ) of the lexical item (LXᵢ) as a function of the canonical form (FC_{ELXI});
a step (E-222-05) for obtaining a form (FX_{ELXIK}) of the lexical entry (ELXᵢₖ);
a step (E-222-06) for obtaining at least one piece of data representing a lexical sense (SEN_{LX}) of each of the forms obtained preliminarily (FLXᵢ, FC_{ELXI}, FX_{ELXIK}).

The last step consists in building the relational graph (Gr_{Rel}^{LXi}) as a function of said lexical entries (ELXᵢ, ELXᵢₖ), of said lexical forms (FLXᵢ, FC_{ELXI}) and said lexical senses (SEN_{LX}) obtained beforehand.

A number of borderline cases can also be described. These borderline cases implement a procedure “specific” to the borderline cases that are applicable to these cases, without the general implementation of the described technique being flawed. Thus, for example, it is possible to process an error during processing if the cursor c1 and c2 are situated on the last possible lexical item. Returning to an example of the sentence “he wishes to “taste” a cheese fondue” where the words are misspelt:

<<ho wants to “taste” ake cheese fandue

This statement generates three situations with exceptions which are:
(c1)ho (c2) wants to “taste” ake cheese fandue (E)
ho wants to “taste” (c1) ake (c2) cheese fandue (E)
ho wants to “taste” ake cheese (c1) fandue (c2) (E)

In this case “ho”, “ake” and “fandue” will not be found as lexical items, and the iteration therefore reduces c2 to c1.

In these cases, the implemented system places c2 again at its initial position just before it coincides with c1, marks the lexical items as unknown and places c1 at c2, and c2 at the end (E). In any case, if c1=E, then the process is stopped.

Ultimately, the unit of cursor shift can be the character (obligatory for agglutinative languages like German or languages without separators as is the case in certain Asian languages). Such a principle can be maintained when the performance and response-time dimensions do not come into consideration. However, for accelerated processing, for example in the French language, it is preferable to have a “faster” unit of cursor movement.

In operational implementation, it is also possible to configure the separators to accelerate the process.

Be that as it may, with this search and identification technique, once a lexical item has been identified in the input statement, a lexical graph associated with this lexical item is obtained. The next phase of the processing, for the lemmatizing module, consists in carrying out a combination of all the individual graphs obtained. One of the advantages of the technique is to have available an original lexical item (LXi) of the greatest possible length: the initial processing algorithm of the statement in natural language therefore gives large-sized lexical items. For example, the sentence “who can do more can do less” is considered to be a lexical item because it is present in the ontological dictionary. From this lexical item, we directly obtain one or more senses. It is not necessary, with the algorithm of the present technique, to break down this sentence to extract the sense of each word and re-compose an overall sense which would be: “anyone who can perform painstaking and difficult tasks is capable of executing easier ones”.

This means that this algorithmic processing leads firstly to greater compactness of the lexical graph associated with the lexical item and secondly easier processing of the lexical item (in preventing unnecessary computations in order to obtain a given sense for a given lexical item). Thus, the efficiency of the processing is reinforced.

In other words, starting from one form, a search is made for all the possible canonical forms of this lexical item. When a lexical item has been identified, it means that the unique associated form (for example “Lemon-Form” of the ontology) has been found.

a) retrieval of the lexical entries from the lexical item: from this form, all the possible lexical entries (for example <<lemon:LexicalEntry>> of the ontology) of this form linked by (“lemon:canonical form” or “lemon:other form”) are retrieved.

b) retrieval of possible canonical forms for the lexical item:
1 For each lexical input associated by a “lemon:other form” relationship, a search is made for the form associated with it by the relationship “lemon:canonical form” which gives us all the possible canonical forms for this lexical item.
2 For all the “lemon:canonical form” relationships: the lexical item found is a canonical form for each lexical entry (they can be many: the lexical item “one” is the canonical form of six lexical entries for example). In this case, it is added to the possible canonical forms of this lexical item.

c) retrieval of semantic data of the lexical item: from the lexical entries found at a), retrieval of all the senses associated with each lexical entry (relationship “lemon:sense” relation) and of all the senses associated with them by the synonym, holonym, definition and other types of relationships.

The creation of the data structure (StrUL) comprising all possible combinations of lexical units, comprises a processing of previously obtained relational graphs (Gr_{Rel}^{LXi}). More particularly, the extracted graphs make it possible to find the possible lexemes for each lexical item. Thus, by comparison, all the possible lemmatized sentences are identified.

According to the technique described, the processing of combinations is relatively fast: should the statement in natural language be short, the number of combinations is limited. It is therefore not difficult to obtain.

Besides, the number of possible combinations is limited by another processing operation relating to the detection of grammatically impossible combinations. This processing is implemented by means of a grammatical module (ModGram). In the grammatical module, the strategies for detecting grammatically impossible combinations are parametrized, for example by using grammatical models.

The creation of this data structure is carried out on the basis of all the relational graphs (Gr_{Rel}^{LXi}) of the lexical items (LXᵢ) of the statement, 1≦i≦N, N designating the number of lexical items identified in the statement in natural language.

### 5.4. Building of the Ontological Dictionary

As explained here above, the lemmatization technique uses an ontological dictionary. One of the advantages of the technique described is that it is multilingual: the proposed algorithm is not concerned with the language used. If need be, depending on the languages, the cursors can be inverted so that the statement is processed from the right to the left rather than from the left to the right.

For the lemmatization algorithm to be efficient, it can be important to have available a dictionary that is itself accurately ordered. The general principle of creation of a dictionary is the following: from an open-data source, a software unit extracts pieces of data and translates them into ontological relationships, i.e. sets of triplets {subject, predicate, object}.

These relationships are of the following orders:
grammatical (grammatical class, type of grammatical derivation etc.).
semantic (register of use of the lexemes, field of use, synonyms, hyperonyms, list of associated concepts etc.).

Once used, the dictionary is updated. A software unit scans the source data to detect additions/modifications/corrections/erasures performed on these sources.

Through these changes, the dictionary is updated. More particularly, according to the proposed technique, the learning system relies on a system of gradual forgetting. A retrieved piece of information reactivates the memorization. In one particular embodiment, the ontology is based on the lemon and lexinfo models. The dictionary uses basic units constituted by the lexical form (LexicalForm), lexical entry (LexicalEntry) and sense (LexicalSense). A “sense” relationship exists between a “sense” entry and a lexical entry. Between a lexical form and a lexical entry, two types of forms exist: either a canonical form or another type of form. The properties between Lexical Entry→LexicalForm contain the types of derivations (gender, number, conjugation, declension, etc.).

The associated LexicalSense instances possess properties:
uses: rare, aged, intransitive etc.
register: familiar, vulgar, slang, etc.
field: Zoology, Technical, Finance, etc.
regionalism.

The LexicalSense instances are associated with other LexicalEntry instances by relationships:
Synonym;
Antonym;
Hyperonym/Hyponym;
Holonym/Meronym;
Definition.

In at least one embodiment, a dictionary is stored in the form of a set of RDF/OWL triplets (object, predicate, subject). This set is based on the W3C standards of the ontologies. As a complement, as explained here above, a dictionary uses the ontological LEMON and LEXINFO for models. The relationships are reified and weighted in order to manage the self-learning system.

According to a first aspect, a learning system is implemented (by means of a learning module). On the basis of a lexeme, the pieces of data are read and interpreted from the source. In the current embodiment, the source used is the French-language Wiktionary. The format of the source is an HTML page and the data are interpreted by means of the XPATH language.

At each passage (at each iteration), the applied processing is the following:
When the lexeme is identified, the following steps are implemented:
[A “form” is created in ontology].
For each possible grammatical class of the lexeme:
   If the lexeme is a canonical form:
   A “lexical entry” is created with this grammatical class in associating the form as “canonical form”.
   For each inflection found:
   Creation of the “form” of the link, “other form” and the nature of the inflection.
   For each sense found:
   Creation of the “sense” of the associated semantic properties (field of use, register of use etc.) and creation of the significant forms of the definition (in Wiktionary: terms of the definition linked to another entry).
   Addition of complementary links and creation of associated forms:
      Synonyms;
      Antonyms;
      Hyperonyms.

The technique described is characterized especially, for the creation of a dictionary, by the implementing of weighting operations. The weighting of the relationships created is initialized at 1 when the relationship does not exist. When the relationship already exists, it is reinforced by a linear function maximized at 1 such that:

Pₙ₊₁=min(Cₐₚ×Pₙ,1)

where

Pₙ₊₁ represents the new weight (at the occurrence n+1);

Cₐₚ represents the learning coefficient;

Pₙ represents the former weight (at the occurrence n).

The “learning coefficient” Cₐₚ is a number strictly greater than 1 (it takes for example the value 2 in one specific embodiment).

The building of the ontological dictionary is divided into two distinct steps: a starting step in which a beginning of a dictionary is created and an updating step that is executed recurrently.

Step 1: Start

During the first passage, a certain number of basic lexemes must be possessed. There are several possibilities:
for example, the use of an arbitrary list of lexemes;
an extraction of the vocabulary via DBPedia and the language SPARQL to accelerate the learning.

Step 2: Updating the Dictionary

Forgetting Phase: All the weighting of the relationships are attenuated polynomially such that:

Pₙ₊₁=C_{forget}×Pₙ^{deg}

where

Pₙ₊₁ represents the new weight (at the occurrence n+1);

C_{forget} represents the coefficient of forgetting;

Pₙ represents the former weight (at the occurrence n);

deg represents the curve of speed of forgetting.

The “coefficient of forgetting” is a positive number strictly below 1 (value positioned at 0.9 in one specific embodiment). “deg” makes it possible to cause exponential forgetfulness. In the specific embodiment, the value is 2. When the reason why knowledge has not been found during an iteration is not that there is any absence of data but that there has been a communications accident, this embodiment makes it possible for the knowledge to be attenuated only very gradually. Then, if this knowledge is retrieved during the next iteration, it will be “definite knowledge” because the amplification it undergoes will be stronger than the attenuation resulting from the accident.

Phase of verification and learning: from all the forms found during previous passages, the general processing described above is applied.

Phase of definitive forgetting: elimination of all relationships, the weighting of which is below the “invalidation threshold”. The “invalidation threshold” is a number strictly below 1 (value 0.01 in one specific embodiment).

In order to ensure optimum freshness of the data of the dictionary, as soon as the updating is terminated, it is started again for a new cycle (only the updating step—step 2—is then implemented inasmuch as it is no longer necessary to carry out an initiation.

### 5.5. Implementing Devices

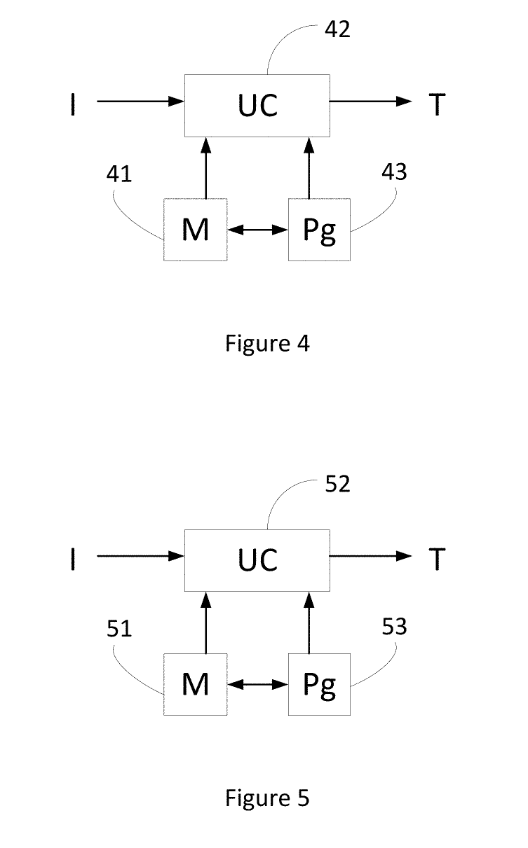

Referring to FIG. 4, we describe a device for creating an ontological dictionary comprising means enabling the execution of the method described here above.

For example, the dictionary-creating device comprises a memory 41 constituted by a buffer memory, a processing unit 42 equipped for example with a microprocessor and driven by the computer program 43 implementing the steps needed to create an ontological dictionary.

At initialization, the code instructions of the computer program 43 are for example loaded into a memory and then executed by the processor of the processing unit 42. The processing unit 42 inputs for example a set of initial lexemes or existing dictionary data. The microprocessor of the processing unit 42 implements the steps of the method for creating or updating a dictionary according to the instructions of the computer program 43 to enable the creation of an ontological dictionary as described here above.

To this end, the device for creating an ontological dictionary comprises, in addition to the buffer memory 41, means for obtaining a piece of external information to the device, such as a set of lexemes or data accessible as open-source data; these means can take the form of an access module, for example a network card, for access to a communications network. The device also comprises means for processing this external data to deliver data formatted and organized according to the ontology of the ontological dictionary; these processing means comprise for example a processor specialized in this task; the device also comprises one or more means of access to one or more databases in order to save and/or update the ontological dictionary. The device also comprises means for updating the dictionary, especially means for weighting relationships between the lexical and/or grammatical forms forming the dictionary.

These means can be driven by the processor of the processing unit 42 according to the computer program 43.

Referring to FIG. 5, we describe a device for creating lexical trees comprising means enabling the execution of the method described here above.

For example, the device for creating lexical trees comprises a memory 51 constituted by a buffer memory, a processing unit 42 equipped for example with a microprocessor and driven by the computer program 53 implementing the steps needed to implement the functions of creation.

At initialization, the code instructions of the computer program 53 are for example loaded into a memory and then executed by the processor of the processing unit 52. The processing unit 52 inputs for example a piece of data external to the terminal called an initial piece of data. The microprocessor of the processing unit 52 implements the steps of the method of creation according to the instructions of the computer program 53 to enable the lemmatizing of a statement in natural language.

To this end, the device for creating lexical trees comprises, in addition to the buffer memory 51, means for obtaining a statement in natural language, called a piece of initial data; these means then can take the form of an entry device, of the keyboard type, or again in the form of an SST (speech to text) module enabling the conversion of speech into text or again in the form of a network interface enabling a device to receive data coming from a communications network. The device also comprises processing means especially means of searching within a database; these processing means comprise for example a dedicated search processor and/or a search module indexed for example on lexical data; the device also comprises means of making tree combinations enabling individual trees to be combined into a plurality of trees.

Theses means can be driven by the processor of the processing unit 52 according to the computer program 53.

1. A method for creating a lexical tree from a statement in natural language, the method being implemented by a natural-language processing module within an electronic device, wherein the method comprises:
receiving a statement in natural language in the form of a string of characters;
iteratively processing said statement as a function of at least one processing parameter and one ontological dictionary, delivering at least one relational graph corresponding to at least one lexical item included in said statement in natural language; and
creating a data structure at output comprising all possible combinations of the lexical items of said statement in natural language on the basis of said at least one relational graph.

2. The method for creating according to claim 1, wherein the iterative processing of said statement as a function of at least one processing parameter and an ontological dictionary comprises:
initializing a cursor (c1) at the beginning of the statement and a cursor (c2) at the end of the statement;
at least one iteration of the following steps, until the cursor is positioned at the end of the statement:
searching, within the dictionary, for a lexical item corresponding to a group of words situated between the cursor c1 and cursor c2; and
when a lexical item is identified in the dictionary by the previous act of searching, taking into account said lexical item and modifying the cursors;
when no lexical item is identified in the dictionary by the act of searching, shifting the position of the cursor c2 to a separator of a preceding word in the statement.

3. The method according to claim 2 wherein taking said lexical item into account and modifying the cursors comprises:
processing the lexical item delivering a relational graph of the lexical item;
positioning the cursor c1 at the position of the cursor c2;
positioning the cursor c2 at the end of the statement;

4. The method according to claim 3, wherein said processing the lexical item delivering a relational graph of the lexical item comprises:
identifying at least one lexical entry associated with the lexical item; this identification is made from the ontological dictionary;
obtaining a lexical form of the lexical item;
obtaining a canonical form of the lexical entry;
identifying at least one lexical entry associated with the lexical form of the lexical item as a function of canonical form;
obtaining a form of the lexical entry;
obtaining at least one piece of data representing a lexical sense of the each of the forms obtained previously;
building said relational graph on the basis of said lexical entries, said lexical forms and said lexical senses obtained previously.

5. A device for creating a lexical tree on the basis of a statement in natural language, the device comprising:
a processor; and
a non-transitory computer-readable medium comprising instructions stored thereon, which when executed by the processor configure the processor to perform acts comprising:
receiving a statement in natural language in the form of a string of characters;
iteratively processing said statement as a function of at least one processing parameter and one ontological dictionary, delivering at least one relational graph corresponding to at least one lexical item included in said statement in natural language;
creating at output a data structure comprising all the possible combinations of lexical items of said statement in natural language as a function of said at least one relational graph.

6. A non-transitory computer-readable medium comprising a computer program product stored thereon, which comprises program code instructions for executing a method of creating a lexical tree from a statement in natural language, when the instructions are executed on a computer, wherein the method comprises:
receiving a statement in natural language in the form of a string of characters;
iteratively processing said statement as a function of at least one processing parameter and one ontological dictionary, delivering at least one relational graph corresponding to at least one lexical item included in said statement in natural language; and
creating a data structure at output comprising all possible combinations of the lexical items of said statement in natural language on the basis of said at least one relational graph.
